(19) United States
(12) Patent Application Publication
(10) Pub. No.: US 2020/0161731 A1
(43) Pub. Date: May 21, 2020

(54) COAXIAL CABLE AND METHOD FOR MANUFACTURING SAME, AND COAXIAL CONNECTOR WITH COAXIAL CABLE

(71) Applicant: Murata Manufacturing Co., Ltd., Kyoto-fu (JP)

(72) Inventors: Yoshihiro HIMI, Nagaokakyo-shi (JP); Daisuke OKADA, Nagaokakyo-shi (JP)

(73) Assignee: Murata Manufacturing Co., Ltd., Kyoto-fu (JP)

(21) Appl. No.: 16/749,921

(22) Filed: Jan. 22, 2020

Related U.S. Application Data
(63) Continuation of application No. PCT/JP2018/023988, filed on Jun. 25, 2018.

(30) Foreign Application Priority Data
Jul. 25, 2017 (JP) 2017-143345

(51) Int. Cl. H01P 1/22; H01P 3/06; H01P 5/08; H01P 11/00; H01R 9/05

(52) U.S. Cl. CPC H01P 1/225; H01P 3/06; H01R 9/0518; H01P 11/005; H01P 5/08

(57) ABSTRACT

A coaxial cable includes a center conductor layer; an insulator layer covering a periphery of the center conductor layer; an outer conductor layer covering a periphery of the insulator layer; a separator layer covering a periphery of the outer conductor layer; a radio wave absorbing resin layer covering a periphery of the separator layer; and an outer sheath covering a periphery of the radio wave absorbing resin layer. The radio wave absorbing resin layer is formed of a material in which a magnetic body is mixed into a resin, and the separator layer is formed by winding a tape-shaped member around the periphery of the outer conductor layer so as to overlap without a gap.

### CROSS-REFERENCE TO RELATED APPLICATIONS

This application claims benefit of priority to International Patent Application No. PCT/JP2018/023988, filed Jun. 25, 2018, and to Japanese Patent Application No. 2017-143345, filed Jul. 25, 2017, the entire contents of each are incorporated herein by reference.

### BACKGROUND

### Technical Field

The present embodiment relates to a coaxial cable and a method for manufacturing the same, and a coaxial connector with coaxial cable.

### Background Art

An existing coaxial cable for transmitting a high-frequency signal or the like has been known as described, for example, in Japanese Examined Utility Model Registration Application Publication No. 60-10026.

The coaxial cable of Japanese Examined Utility Model Registration Application Publication No. 60-10026 includes a center conductor layer, an insulator layer, an outer conductor layer, and an outer sheath in order from the center side.

### SUMMARY

Meanwhile, in the field of coaxial cables, transmission performance (transmission loss characteristics) of a high-frequency signal by a coaxial cable is regarded as important. There is a demand for development of a technology capable of suppressing deterioration in transmission loss characteristics of a high-frequency signal, including the coaxial cable as disclosed in Japanese Examined Utility Model Registration Application Publication No. 60-10026.

Accordingly, the present embodiment provides a coaxial cable capable of suppressing deterioration in transmission loss characteristics of a high-frequency signal and a method for manufacturing the same, and a coaxial connector with coaxial cable.

A coaxial cable according to the present embodiment includes a center conductor layer; an insulator layer covering a periphery of the center conductor layer; an outer conductor layer covering a periphery of the insulator layer; a separator layer covering a periphery of the outer conductor layer; a radio wave absorbing resin layer covering a periphery of the separator layer; and an outer sheath covering a periphery of the radio wave absorbing resin layer. The radio wave absorbing resin layer is formed of a material in which a magnetic body is mixed into a resin, and the separator layer is formed by winding a tape-shaped member around the periphery of the outer conductor layer so as to overlap without a gap.

Furthermore, a coaxial connector with coaxial cable according to the present embodiment includes the coaxial cable; an inner terminal connected to the center conductor portion of the coaxial cable; an outer terminal connected to the outer conductor portion of the coaxial cable; and an insulating member disposed between the inner terminal and the outer terminal, the coaxial connector with coaxial cable is connected to a counterpart connector with the inner terminal and the outer terminal interposed therebetween.

Furthermore, a method for manufacturing a coaxial cable according to the present embodiment includes the steps of preparing an intermediate body including a center conductor layer, an insulator layer covering a periphery of the center conductor layer, and an outer conductor layer covering a periphery of the insulator layer; forming a separator layer covering a periphery of the outer conductor layer by winding a tape-shaped member around a periphery of the intermediate body so as to overlap without a gap; forming a radio wave absorbing resin layer covering a periphery of the separator layer by performing extrusion molding of a material in which a magnetic body is mixed into a resin on the periphery of the intermediate body around which the separator layer is formed; and forming an outer sheath so as to cover a periphery of the radio wave absorbing resin layer.

According to a coaxial cable and a method for manufacturing the same, and a coaxial connector with coaxial cable according to the present embodiment, it is possible to suppress deterioration in transmission loss characteristics of a signal.

### BRIEF DESCRIPTION OF THE DRAWINGS

FIG. 1A is a vertical cross-sectional view of a coaxial cable according to a first embodiment;

FIG. 1B is a perspective view of the coaxial cable according to the first embodiment;

FIG. 2 is a perspective view of a coaxial connector with coaxial cable to which the coaxial cable according to the first embodiment is connected;

FIG. 3 is an exploded perspective view illustrating the coaxial connector and the coaxial cable (before connection) according to the first embodiment;

FIG. 4A is a perspective view of the coaxial cable including a separator layer according to the first embodiment;

FIG. 4B is an enlarged view of a portion B of FIG. 4A;

FIG. 5 is a development view of the separator layer and an outer conductor layer;

FIG. 6A is a diagram for explaining a method for manufacturing the coaxial cable according to the first embodiment;

FIG. 6B is a diagram for explaining the method for manufacturing the coaxial cable according to the first embodiment;

FIG. 6C is a diagram for explaining the method for manufacturing the coaxial cable according to the first embodiment;

FIG. 6D is a diagram for explaining the method for manufacturing the coaxial cable according to the first embodiment;

FIG. 6E is a diagram for explaining the method for manufacturing the coaxial cable according to the first embodiment;

FIG. 6F is a diagram for explaining the method for manufacturing the coaxial cable according to the first embodiment;

FIG. 7A is a perspective view of a coaxial cable including a separator layer according to a second embodiment; and

FIG. 7B is an enlarged view of a portion D of FIG. 7A.

### DETAILED DESCRIPTION

According to a first aspect of the present embodiment, there is provided a coaxial cable including a center conductor layer; an insulator layer covering a periphery of the center conductor layer; an outer conductor layer covering a periphery of the insulator layer; a separator layer covering a periphery of the outer conductor layer; a radio wave absorbing resin layer covering a periphery of the separator layer; and an outer sheath covering a periphery of the radio wave absorbing resin layer. the radio wave absorbing resin layer is formed of a material in which a magnetic body is mixed into a resin, and the separator layer is formed by winding a tape-shaped member around the periphery of the outer conductor layer so as to overlap without a gap.

According to the configuration described above, by forming the radio wave absorbing resin layer by the material in which the magnetic body is mixed into the resin, a shielding property against external radio waves can be improved, and deterioration in transmission loss characteristics of a signal by the coaxial cable can be suppressed. Furthermore, by forming the separator layer between the radio wave absorbing resin layer and the outer conductor layer by winding the tape-shaped member so as to overlap without a gap, it is possible to prevent the magnetic body, which is a material constituting the radio wave absorbing resin layer, from flowing into the inside of the outer conductor layer. This makes it possible to further suppress deterioration in transmission loss characteristics of the signal by the coaxial cable.

According to a second aspect of the present embodiment, there is provided the coaxial cable according to the first aspect, in which the separator layer is formed by spirally winding the tape-shaped member toward an axial direction of the coaxial cable. According to the configuration described above, the separator layer can be formed by a simple method.

According to a third aspect of the present embodiment, there is provided the coaxial cable according to the first aspect, in which the separator layer is formed by winding the tape-shaped member in a circumferential direction of the coaxial cable while making a long side of the tape-shaped member parallel to the axial direction of the coaxial cable. According to the configuration described above, the separator layer can be formed by a simple method.

According to a fourth aspect of the present embodiment, there is provided the coaxial cable according to any one of the first aspect to the third aspect, in which the tape-shaped member constituting the separator layer is a PET film. According to the configuration described above, the separator layer can be formed at a low cost.

According to a fifth aspect of the present embodiment, there is provided the coaxial cable according to any one of the first aspect to the fourth aspect, in which the tape-shaped member constituting the separator layer includes a magnetic body. According to the configuration described above, it is possible to provide a radio wave absorbing function not only to the radio wave absorbing resin layer but also to the separator layer, and it is possible to further suppress deterioration in the transmission loss characteristics of the signal by the coaxial cable.

According to a sixth aspect of the present embodiment, there is provided the coaxial cable according to any one of the first aspect to the fifth aspect, in which in the material forming the radio wave absorbing resin layer, the resin is a urethane-based resin and the magnetic body is a ferrite. According to the configuration described above, by using a general-purpose material, a production cost can be reduced.

According to a seventh aspect of the present embodiment, there is provided a coaxial connector with coaxial cable including the coaxial cable according to any one of the configurations discussed herein; an inner terminal connected to the center conductor layer of the coaxial cable; an outer terminal connected to the outer conductor layer of the coaxial cable; and an insulating member is between the inner terminal and the outer terminal, the coaxial connector with coaxial cable being connected to a counterpart connector with the inner terminal and the outer terminal interposed therebetween.

According to the configuration described above, by using the coaxial cable in which deterioration in the transmission loss characteristics of the signal is suppressed, deterioration in transmission loss characteristics of the signal by the coaxial connector with coaxial cable can be suppressed.

According to an eighth aspect of the present embodiment, there is provided a method for manufacturing a coaxial cable including the steps of preparing an intermediate body including a center conductor layer, an insulator layer covering a periphery of the center conductor layer, and an outer conductor layer covering a periphery of the insulator layer; forming a separator layer covering a periphery of the outer conductor layer by winding a tape-shaped member around a periphery of the intermediate body so as to overlap without a gap; forming a radio wave absorbing resin layer covering a periphery of the separator layer by performing extrusion molding of a material in which a magnetic body is mixed into a resin on the periphery of the intermediate body around which the separator layer is formed; and forming an outer sheath so as to cover a periphery of the radio wave absorbing resin layer.

According to the method described above, by forming the radio wave absorbing resin layer by the material in which the magnetic body is mixed into the resin, a shielding property against external radio waves can be improved, and deterioration in transmission loss characteristics of a signal by the coaxial cable can be suppressed. Furthermore, by forming the separator layer between the radio wave absorbing resin layer and the outer conductor layer by winding the tape-shaped member so as to overlap without a gap, it is possible to prevent the magnetic body, which is a material constituting the radio wave absorbing resin layer, from flowing into the inside of the outer conductor layer. This makes it possible to suppress deterioration in the transmission loss characteristics of the signal by the coaxial cable.

According to a ninth aspect of the present embodiment, there is provided the method for manufacturing the coaxial cable according to the eighth aspect, in which the step of forming the separator layer includes a step of spirally winding the tape-shaped member toward an axial direction of the coaxial cable. According to the method described above, the separator layer can be formed by a simple method.

According to a tenth aspect of the present embodiment, there is provided the method for manufacturing the coaxial cable according to the eighth aspect, in which the step of forming the separator layer includes a step of winding the tape-shaped member in a circumferential direction of the coaxial cable while making a long side of the tape-shaped member parallel to the axial direction of the coaxial cable. According to the method described above, the separator layer can be formed by a simple method.

According to an eleventh aspect of the present embodiment, there is provided the method for manufacturing the coaxial cable according to any one of the eighth aspect to the tenth aspect, in which in the step of forming the separator layer, as the tape-shaped member, a PET film is used. According to the method described above, the separator layer can be formed at a low cost.

According to a twelfth aspect of the present embodiment, there is provided the method for manufacturing the coaxial cable according to any one of the eighth aspect to the eleventh aspect, in which in the step of forming the separator layer, as the tape-shaped member, a tape-shaped member including a magnetic body is used. According to the method described above, by providing a radio wave absorbing function not only to the radio wave absorbing resin layer but also to the separator layer, a shielding property against external radio waves can be further improved, and the performance of the coaxial cable can be further improved.

According to a thirteenth aspect of the present embodiment, there is provided the method for manufacturing the coaxial cable according to any one of the eighth aspect to the twelfth aspect, in which in the step of forming the radio wave absorbing resin layer, by performing extrusion molding of a material in which the resin is a urethane-based resin and the magnetic body is a ferrite, the radio wave absorbing resin layer is formed. According to the method described above, by using a general-purpose material, a production cost can be reduced.

Exemplary embodiments of a coaxial cable and a method for manufacturing the same according to the present embodiment will be described below with reference to the accompanying drawings. The present embodiment is not limited to a specific configuration of the following embodiments, and a configuration based on the same technical idea is included in the present embodiment.

### First Embodiment

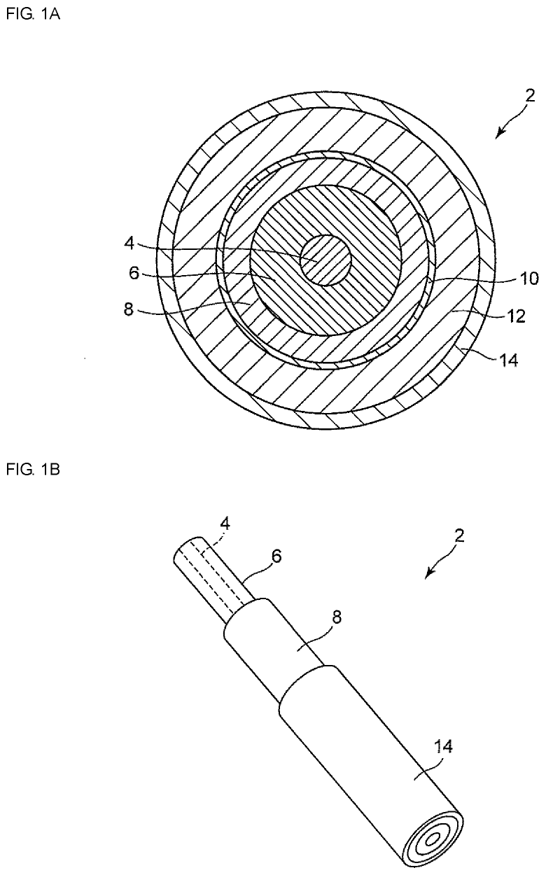

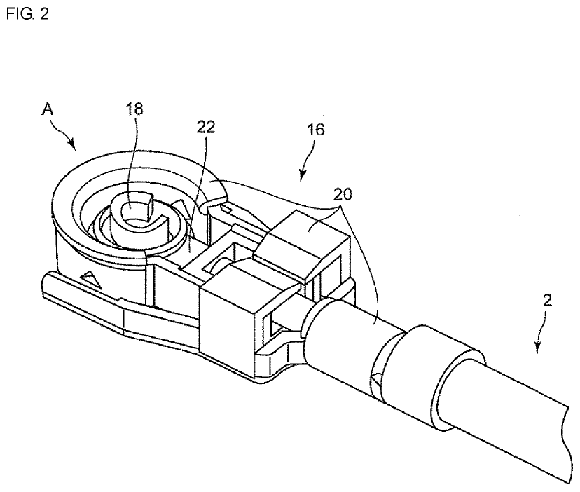

FIG. 1A is a vertical cross-sectional view of a coaxial cable 2 according to a first embodiment, and FIG. 1B is a perspective view of the coaxial cable 2. The coaxial cable 2 illustrated in FIGS. 1A and 1B includes a center conductor layer 4, an insulator layer 6, an outer conductor layer 8, a separator layer 10, a radio wave absorbing resin layer 12, and an outer sheath 14 in this order from the center side. In FIG. 1B, the separator layer 10 and the radio wave absorbing resin layer 12 are in the inner side portion of the outer sheath 14, and a portion covered with the outer sheath 14 is not exposed.

As illustrated in FIG. 1B, the outer periphery of the center conductor layer 4 is covered by the insulator layer 6 as a whole. Additionally, the insulator layer 6, the outer conductor layer 8, and the outer sheath 14 are exposed in this order from a tip end side of the coaxial cable 2.

The embodiment of the present disclosure is particularly characterized in a point that, in addition to a general coaxial cable configuration including the center conductor layer 4, the insulator layer 6, the outer conductor layer 8, and the outer sheath 14, by including the separator layer 10 and the radio wave absorbing resin layer 12, deterioration in transmission loss characteristics of a signal by the coaxial cable 2 is suppressed. A specific characteristic will be described later.

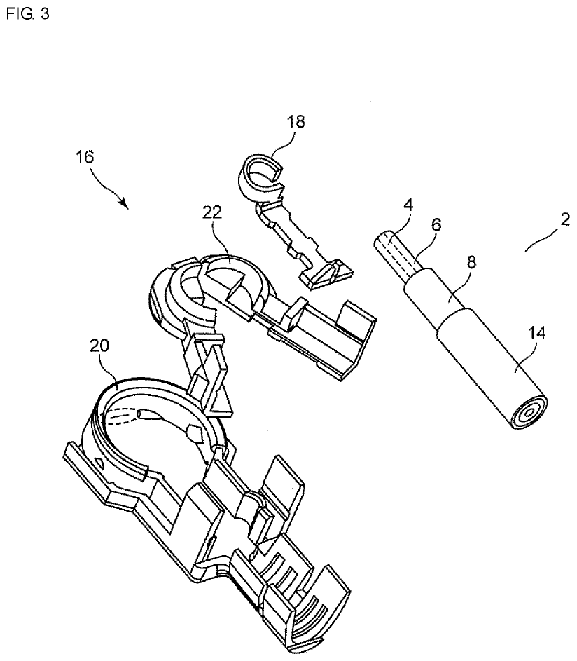

The coaxial cable 2 illustrated in FIGS. 1A and 1B is used by being connected to a coaxial connector 16 illustrated in FIG. 2 and FIG. 3.

FIG. 2 is a perspective view (a state after connection) illustrating a state in which the coaxial cable 2 is connected to the coaxial connector 16 according to the first embodiment, and FIG. 3 is an exploded perspective view (a state before connection) of the coaxial connector 16.

The coaxial connector 16 according to the first embodiment includes an inner terminal 18, an outer terminal 20, and an insulator 22. The inner terminal 18 and the outer terminal 20 are terminal portions of the coaxial connector 16, constituted of a conductive material. The insulator 22 is an insulating member (for example, a resin) that is between the inner terminal 18 and the outer terminal 20.

In the state after the connection illustrated in FIG. 2, the inner terminal 18 is connected to the center conductor layer 4 of the coaxial cable 2 (not illustrated), and the outer terminal 20 is connected to the outer conductor layer 8 (not illustrated). The coaxial connector 16 is configured as an L-shaped coaxial connector, and the inner terminal 18 and the outer terminal 20 at a tip end portion A in FIG. 2 are fitted and connected to a terminal (not illustrated) of a counterpart connector.

The separator layer 10 and the radio wave absorbing resin layer 12 of the coaxial cable 2 described above will be explained.

The separator layer 10 is a layer for separating the outer conductor layer 8 and the radio wave absorbing resin layer 12 from each other. As will be described later, the separator layer 10 according to the present first embodiment is formed by spirally winding a tape-shaped member toward an axial direction of the coaxial cable.

The radio wave absorbing resin layer 12 is a layer having a function of absorbing radio waves, and is formed of a resin. By providing the radio wave absorbing resin layer 12, it is possible to improve a shielding property against external radio waves, and it is possible to suppress deterioration in transmission loss characteristics of a signal by the coaxial cable 2.

The radio wave absorbing resin layer 12 is formed of a material in which a magnetic body is mixed into a resin while containing a resin as the main material. By mixing the magnetic body, it is possible to exhibit the radio wave absorbing function. Additionally, by containing the resin, the radio wave absorbing resin layer 12 can be manufactured by extrusion molding.

In the present first embodiment, a urethane-based resin is used as the resin, and ferrite is used as the magnetic body. By using such a general-purpose material, the radio wave absorbing resin layer 12 can be formed at a low cost.

When performing extrusion molding of the radio wave absorbing resin layer 12 on the periphery of the separator layer 10, when there is a gap at the separator layer 10, the magnetic body in the material forming the radio wave absorbing resin layer 12 flows into the inside of the outer conductor layer 8 in some cases. In particular, since the outer conductor layer 8 is formed of a braided conductor layer in which a plurality of wires made of copper, a copper alloy, or the like having high conductivity is braided, or a winding conductor layer in which a plurality of wires made of copper, a copper alloy, or the like having high conductivity is wound, there is a gap. When the material in which the magnetic body is mixed into the resin flows into the gap, the magnetic body flows into the inside of the outer conductor layer 8 (a side closer to the center conductor). A high-frequency current flows through the inside of the outer conductor layer 8, and when there is the magnetic body therein, attenuation of electric power occurs. As described above, when the magnetic body enters the inside of the outer conductor layer 8, there is a risk that deterioration in the transmission loss characteristics of the signal by the outer conductor layer 8 will occur, and deterioration in the transmission loss characteristics of the signal by the coaxial cable 2 will occur.

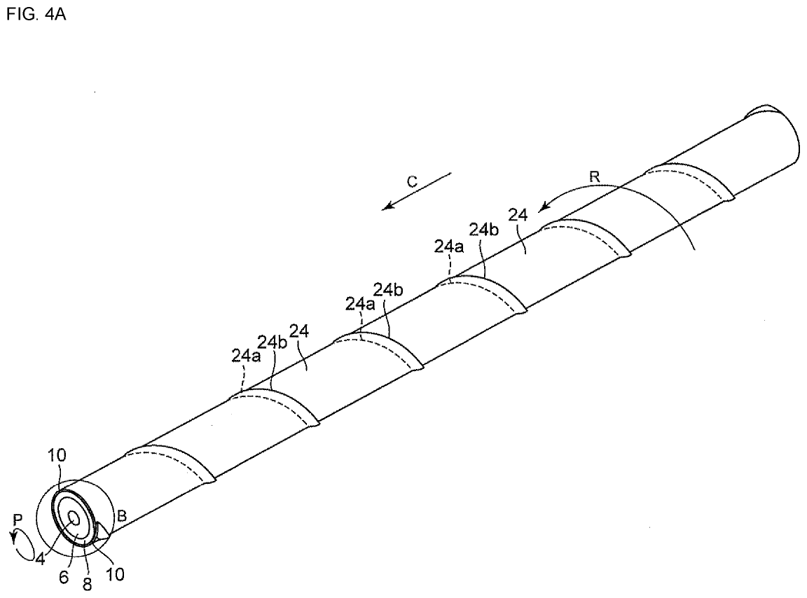

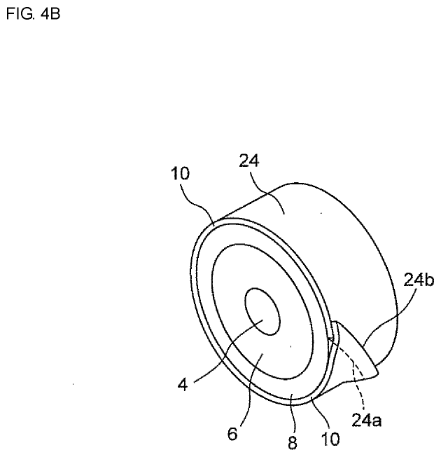

In order to prevent the performance deterioration of the coaxial cable 2 as described above, in the coaxial cable 2 according to the present first embodiment, the separator layer 10 is formed by spirally winding the tape-shaped member without a gap such that a gap is not formed therein. Specifically, description will be made with reference to FIGS. 4A and 4B.

FIG. 4A is a perspective view illustrating the separator layer 10 according to the first embodiment, and FIG. 4B is an enlarged view of a portion B in FIG. 4A. In FIGS. 4A and 4B, the radio wave absorbing resin layer 12 and the outer sheath 14 are not illustrated.

As illustrated in FIG. 4A, the separator layer 10 according to the first embodiment is formed by spirally winding a tape-shaped member (tape member) 24. The tape member 24 is wound so as to have a spiral-shape toward an axial direction C of the coaxial cable 2, in a spiral direction R around the axial direction C as the center.

The tape member 24 according to the present first embodiment has no adhesive function on both surfaces, and is positioned by simply winding.

The tape member 24 has a first long side 24a and a second long side 24b as two long sides. As illustrated in FIG. 4A, an end portion having the first long side 24a and an end portion having the second long side 24b are wound so as to overlap with each other.

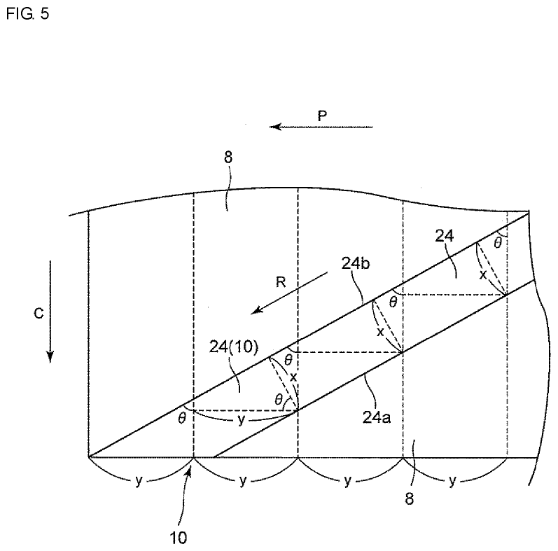

The winding method of the tape member 24 described above will be further explained with reference to FIG. 5. FIG. 5 is a development view in which the separator layer 10 and the outer conductor layer 8 are developed in a circumferential direction P of the coaxial cable 2.

In FIG. 5, a width of the tape member 24 is taken as x, an outer periphery (a length corresponding to one turn) of the outer conductor layer 8 is taken as y, and a winding angle (inclination angle of the first long side 24a and the second long side 24b of the tape member 24 relative to the axial direction C) of the tape member 24 is taken as θ.

In the relationship illustrated in FIG. 5, in a case where the tape member 24 is wound such that the first long side 24a and the second long side 24b just overlap, Expression 1 indicated below is established.

cos θ=x/y (Expression 1)

On the other hand, in order to make the end portion having the first long side 24a and the end portion having the second long side 24b overlap with each other as in the present first embodiment, designing is carried out such that Expression 2 indicated below is established.

0<cos θ<x/y (Expression 2)

By setting of the inclination angle as described above, the tape member 24 is wound such that the end portion having the first long side 24a and the end portion having the second long side 24b overlap with each other, and no gap is formed between the first long side 24a and the second long side 24b. With this, the outer conductor layer 8 at the inner side portion of the tape member 24 is not exposed, and the outer periphery of the outer conductor layer 8 is covered with the separator layer 10 as a whole. According to the configuration described above, since the outer conductor layer 8 and the radio wave absorbing resin layer 12 can be completely separated from each other by the separator layer 10, it is possible to prevent the magnetic body in the material forming the radio wave absorbing resin layer 12 from entering the inside of the outer conductor layer 8 when performing extrusion molding of the radio wave absorbing resin layer 12 as described above. This makes it possible to suppress deterioration in transmission loss characteristics of the signal by the outer conductor layer 8.

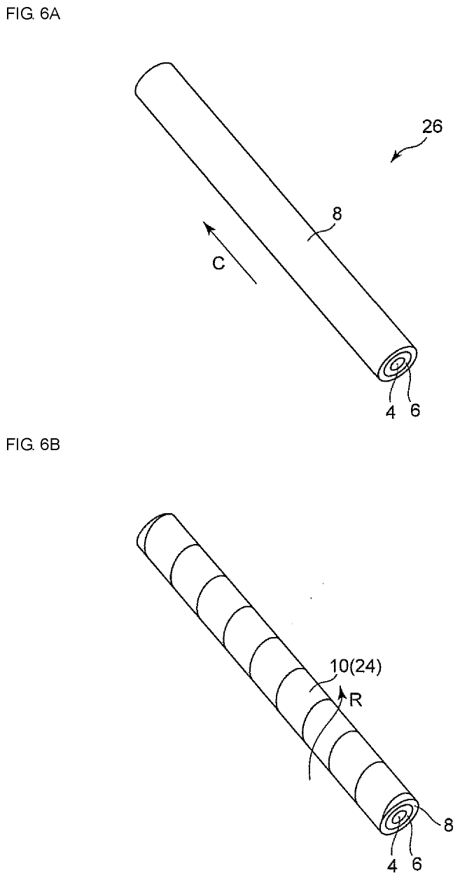

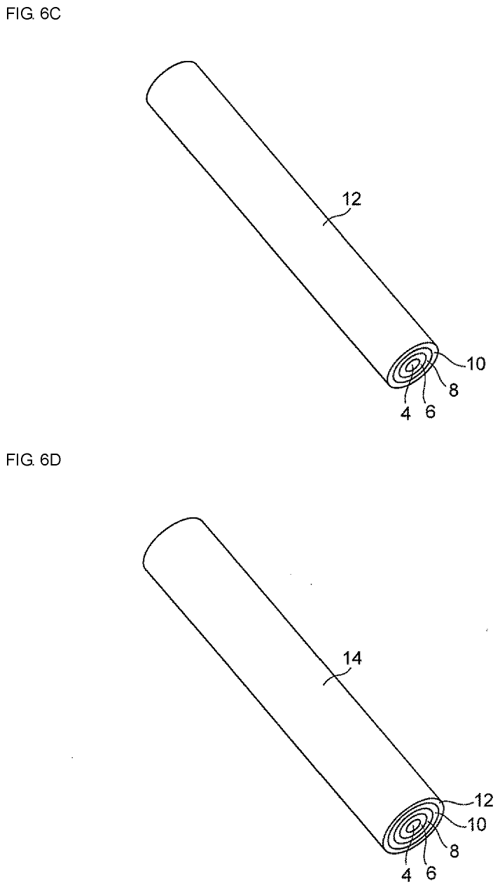

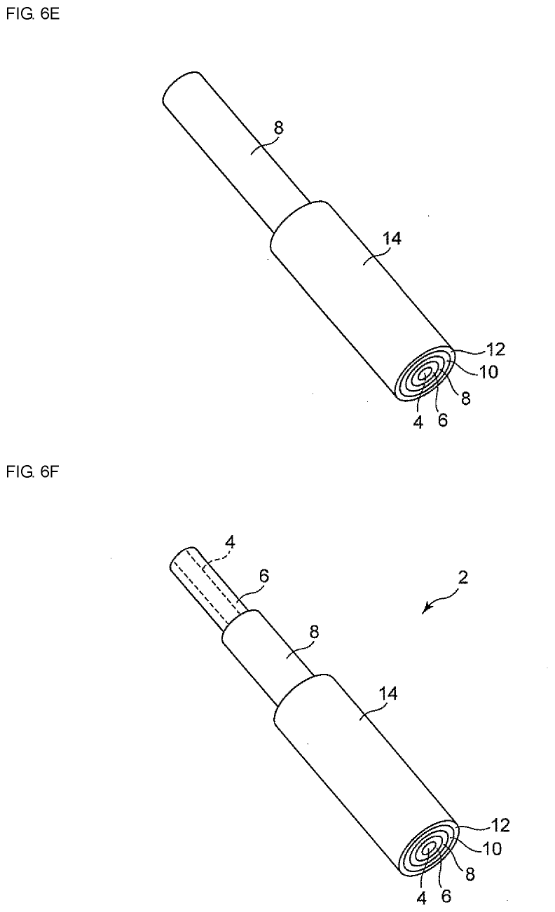

Next, an example of a method for manufacturing the coaxial cable 2 described above will be explained with reference to FIG. 6A to FIG. 6F.

First, an intermediate body is prepared (step S1). Specifically, as illustrated in FIG. 6A, an intermediate body 26 is prepared which includes the center conductor layer 4, the insulator layer 6, and the outer conductor layer 8. In the intermediate body 26 illustrated in FIG. 6A, a case in which lengths of the center conductor layer 4, the insulator layer 6, and the outer conductor layer 8 in the axial direction C are the same is illustrated as an example.

Next, the separator layer 10 is formed (step S2). Specifically, the tape member 24 is spirally wound around the periphery of the outer conductor layer 8 of the intermediate body 26. With this, as illustrated in FIG. 6B, the separator layer 10 covering the periphery of the outer conductor layer 8 is formed. By winding the tape member 24 with the winding angle explained with reference to FIG. 4A and FIG. 5, it is possible to form the tape member 24 such that the end portion having the first long side 24a and the end portion having the second long side 24b overlap with each other and no gap is formed in the tape member 24.

Next, the radio wave absorbing resin layer 12 is formed (step S3). Specifically, extrusion molding of the material in which the magnetic body is mixed into the resin is performed on the periphery of the intermediate body 26 in which the separator layer 10 is formed, by using an extruder. With this, as illustrated in FIG. 6C, the radio wave absorbing resin layer 12 covering the periphery of the separator layer 10 is formed.

As described above, by forming the radio wave absorbing resin layer 12 with the material containing the resin, manufacturing by extrusion molding becomes possible. This enables manufacturing by extrusion molding, which cannot be achieved in a case where a powder material instead of the resin is applied to form the radio wave absorbing resin layer. This makes it possible to shorten time required to form the radio wave absorbing resin layer 12 in comparison with a case of forming by coating.

Furthermore, although the magnetic body is mixed into the material constituting the radio wave absorbing resin layer 12, since the separator layer 10 formed in previous step S2 is formed without a gap, the magnetic body contained in the resin does not flow into the inside of the outer conductor layer 8 at the time of the extrusion molding in step S3. This makes it possible to suppress deterioration in transmission loss characteristics of the signal by the outer conductor layer 8.

Next, the outer sheath 14 is formed (step S4). Specifically, the outer sheath 14 is formed by, for example, extrusion molding using a predetermined material (for example, PFA (perfluoroalkoxy fluororesin)). With this, as illustrated in FIG. 6D, the outer sheath 14 covering the periphery of the radio wave absorbing resin layer 12 is formed.

In this manner, both the outer sheath 14 and the radio wave absorbing resin layer 12 are formed by extrusion molding. According to the method described above, the radio wave absorbing resin layer 12 and the outer sheath 14 can be continuously formed, and the productivity of the coaxial cable 2 can be improved.

Next, the outer conductor layer 8 is exposed (step S5). Specifically, for example, the separator layer 10, the radio wave absorbing resin layer 12, and the outer sheath 14 located in an outer side portion of the outer conductor layer 8 are partially removed (stripped) from the tip end side by using a coaxial cable stripping machine. As a result, as illustrated in FIG. 6E, the outer conductor layer 8 is partially exposed from the tip end side.

Here, as described above, the separator layer 10 is constituted by simply winding the tape-shaped member 24 which has no adhesive surface on each surface. Therefore, the radio wave absorbing resin layer 12 and the outer sheath 14 can both be easily removed from the periphery of the outer conductor layer 8.

Next, the insulator layer 6 is exposed (step S6). Specifically, for example, the outer conductor layer 8 located in an outer side portion of the insulator layer 6 is partially removed (stripped) from the tip end side by using a coaxial cable stripping machine. As a result, as illustrated in FIG. 6F, the insulator layer 6 is partially exposed from the tip end side.

Through steps S1 to S6 as described above, the coaxial cable 2 including the center conductor layer 4, the insulator layer 6, the outer conductor layer 8, the separator layer 10 (not illustrated), the radio wave absorbing resin layer 12 (not illustrated), and the outer sheath 14 as illustrated in FIG. 6F can be manufactured.

### Second Embodiment

A coaxial cable according to a second embodiment of the present embodiment will be described. Note that in the second embodiment, points different from those in the first embodiment are mainly described, and the same or equivalent configurations as those in the first embodiment will be described with the same reference numerals.

In the first embodiment, the separator layer 10 is formed by spirally winding the tape member 24, but in the second embodiment, is formed by winding the tape member in the circumferential direction P (longitudinal winding), which is different from the first embodiment.

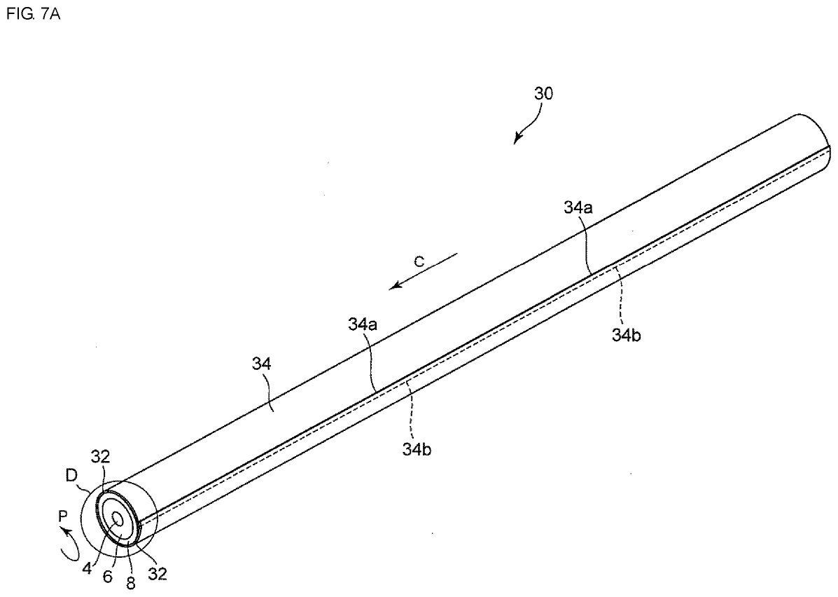

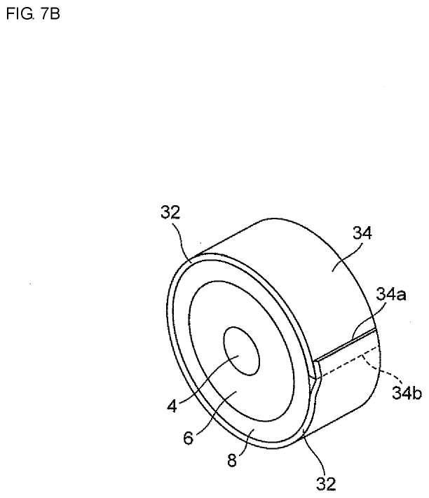

A separator layer 32 of a coaxial cable 30 according to the second embodiment is illustrated in FIGS. 7A and 7B. FIG. 7A is a perspective view illustrating the separator layer 32 according to the second embodiment, and FIG. 7B is an enlarged view of a portion D in FIG. 7A. In FIGS. 7A and 7B, the radio wave absorbing resin layer 12 and the outer sheath 14 are not illustrated.

As illustrated in FIG. 7A, the separator layer 32 according to the second embodiment is formed by winding a tape member 34, which extends along the axial direction C, in the circumferential direction P.

The tape member 34 has a first long side 34a and a second long side 34b as two long sides. As illustrated in FIG. 7A, the tape member 34 is wound in the circumferential direction P in a state in which the first long side 34a and the second long side 34b extend parallel to the axial direction C, and an end portion having the first long side 34a and an end portion having the second long side 34b are configured so as to overlap with each other.

Even in a winding method different from the spiral winding as described above, winding is performed such that the end portion having the first long side 34a and the end portion having the second long side 34b overlap with each other, and no gap is formed between the first long side 34a and the second long side 34b. With this, the outer conductor layer 8 at the inner side portion of the tape member 24 is not exposed, and the outer periphery of the outer conductor layer 8 is covered as a whole. This makes it possible, when the radio wave absorbing resin layer 12 is formed by extrusion molding, to prevent the magnetic body in the material forming the radio wave absorbing resin layer 12 from flowing into the inside of the outer conductor layer 8, and to suppress deterioration in the transmission loss characteristics of the signal by the coaxial cable 30.

As in the first and second embodiments, in order to form the separator layers 10 and 32 without a gap, the tape member may be wound around the periphery of the outer conductor layer 8 so as to overlap without a gap. In other words, forming may be performed by winding the tape member such that the end portion having the first long side and the end portion having the second long side overlap with each other.

Among various winding methods of the tape member, in particular, when forming by winding in a “spiral shape” as in the first embodiment, or forming by winding in a “longitudinal winding” as in the second embodiment, the separator layers 10 and 32 can be formed by a simple method.

Although the present embodiment has been described thus far by using the first and second embodiments described above, the present embodiment is not limited to the first and second embodiments described above. For example, although a case where the PET (polyethylene terephthalate) film is used as the tape members 24 and 34 forming the separator layers 10 and 32 is described in the first and second embodiments, the present embodiment is not limited to this case, and any tape member other than the PET film may be used. For example, a polyimide film may be used instead of the PET film. Alternatively, a foil containing a magnetic body, that is, a metal foil may be used, and the separator layer may also be provided with a radio wave absorbing function. When the outer conductor layer 8 is covered with a tape member containing a magnetic body, the magnetic body does not infiltrate into the outer conductor layer 8 and remains in contact with the surface of the outer conductor layer 8. Since almost no high-frequency current flows through the surface of the outer conductor layer 8, deterioration in the transmission loss characteristics does not occur even when the magnetic body comes into contact therewith. Therefore, even when the separator layer is provided with a radio wave absorbing function by using the foil containing the magnetic body, that is, the metal foil for the tape member forming the separator layer, deterioration in transmission loss characteristics can be suppressed. Alternatively, a film in which copper or the like is vapor-deposited on a resin may be used, and the separator layer may be provided with a shielding function. By also providing the separator layer with the radio wave absorbing function and the shielding function as described above, deterioration in transmission loss characteristics of the signal by the coaxial cables 2 and 30 can be further suppressed. On the other hand, when the tape members 24 and 34 are formed of a PET film or a polyimide film, the separator layer 10 can be formed at a low cost.

Furthermore, in the first and second embodiments, although the case where the resin is a urethane-based resin and the magnetic body is ferrite in the material for forming the radio wave absorbing resin layer 12 is described, the present embodiment is not limited thereto and any resin (PFA or the like) and any magnetic body (metal powder or the like) may also be used. However, by using a urethane-based resin for the resin and using ferrite for the magnetic body, the production cost of the radio wave absorbing resin layer 12 can be reduced by using a general-purpose material.

Although the present disclosure has been fully described in connection with the preferred embodiments with reference to the accompanying drawings, various changes and modifications are apparent to those skilled in the art. It is to be understood that such changes and modifications are included within the scope of the present disclosure as defined by the appended claims unless they depart therefrom. Change in combination and order of the elements in the embodiments can be achieved without departing from the scope and spirit of the present disclosure.

It should be noted that, by appropriately combining arbitrary embodiments or modifications among the various embodiments and modifications described above, effects provided by them can be obtained.

The present embodiment can be applied to a coaxial cable and a method for manufacturing the same, and a coaxial connector with coaxial cable.

What is claimed is:

1. A coaxial cable comprising:
a center conductor layer;
an insulator layer covering a periphery of the center conductor layer;
an outer conductor layer covering a periphery of the insulator layer;
a separator layer covering a periphery of the outer conductor layer, the separator layer being formed by a tape-shaped member wound around the periphery of the outer conductor layer;
a radio wave absorbing resin layer covering a periphery of the separator layer such that the separator layer prevents contact between the radio wave absorbing resin layer and the outer conductor layer, the radio wave absorbing resin layer being formed of a material in which a magnetic body is mixed into a resin; and
an outer sheath covering a periphery of the radio wave absorbing resin layer.

2. The coaxial cable according to claim 1, wherein
the separator layer is formed by spirally winding the tape-shaped member toward an axial direction of the coaxial cable.

3. The coaxial cable according to claim 1, wherein
the separator layer is formed by winding the tape-shaped member in a circumferential direction of the coaxial cable while making a long side of the tape-shaped member parallel to the axial direction of the coaxial cable.

4. The coaxial cable according to claim 1, wherein
the tape-shaped member constituting the separator layer is a PET film.

5. The coaxial cable according to claim 1, wherein
the tape-shaped member constituting the separator layer includes a magnetic body.

6. The coaxial cable according to claim 1, wherein
in the material forming the radio wave absorbing resin layer, the resin is a urethane-based resin and the magnetic body is a ferrite.

7. A coaxial connector comprising:
the coaxial cable according to claim 1;
an inner terminal connected to the center conductor layer of the coaxial cable;
an outer terminal connected to the outer conductor layer of the coaxial cable; and
an insulating member disposed between the inner terminal and the outer terminal,
the coaxial connector with coaxial cable being connected to a counterpart connector between the inner terminal and the outer terminal.

8. The coaxial cable according to claim 2, wherein
the tape-shaped member constituting the separator layer is a PET film.

9. The coaxial cable according to claim 2, wherein
the tape-shaped member constituting the separator layer includes a magnetic body.

10. The coaxial cable according to claim 2, wherein
in the material forming the radio wave absorbing resin layer, the resin is a urethane-based resin and the magnetic body is a ferrite.

11. A coaxial connector comprising:
the coaxial cable according to claim 2;
an inner terminal connected to the center conductor layer of the coaxial cable;
an outer terminal connected to the outer conductor layer of the coaxial cable; and
an insulating member disposed between the inner terminal and the outer terminal,
the coaxial connector with coaxial cable being connected to a counterpart connector between the inner terminal and the outer terminal.

12. A method for manufacturing a coaxial cable, the method comprising:
preparing an intermediate body including a center conductor layer, an insulator layer covering a periphery of the center conductor layer, and an outer conductor layer covering a periphery of the insulator layer;
forming a separator layer covering a periphery of the outer conductor layer by winding a tape-shaped member around a periphery of the intermediate body;
forming a radio wave absorbing resin layer covering a periphery of the separator layer by performing extrusion molding of a material in which a magnetic body is mixed into a resin on the periphery of the intermediate body around which the separator layer is formed, such that the separator layer prevents contact between the radio wave absorbing resin layer and the outer conductor layer; and
forming an outer sheath so as to cover a periphery of the radio wave absorbing resin layer.

13. The method for manufacturing the coaxial cable according to claim 12, wherein
the forming of the separator layer includes spirally winding the tape-shaped member toward an axial direction of the coaxial cable.

14. The method for manufacturing the coaxial cable according to claim 12,
wherein the forming of the separator layer includes winding the tape-shaped member in a circumferential direction of the coaxial cable while making a long side of the tape-shaped member parallel to the axial direction of the coaxial cable.

15. The method for manufacturing the coaxial cable according to claim 12,
wherein in the forming of the separator layer, as the tape-shaped member, a PET film is used.

16. The method for manufacturing the coaxial cable according to claim 12, wherein
in the forming of the separator layer, as the tape-shaped member, a tape-shaped member including a magnetic body is used.

17. The method for manufacturing the coaxial cable according to claim 12,
wherein in the forming of the radio wave absorbing resin layer, by performing extrusion molding of a material in which the resin is a urethane-based resin and the magnetic body is a ferrite, the radio wave absorbing resin layer is formed.

18. The method for manufacturing the coaxial cable according to claim 13,
wherein in the forming of the separator layer, as the tape-shaped member, a PET film is used.

19. The method for manufacturing the coaxial cable according to claim 13, wherein
in the forming of the separator layer, as the tape-shaped member, a tape-shaped member including a magnetic body is used.

20. The method for manufacturing the coaxial cable according to claim 13,
wherein in the forming of the radio wave absorbing resin layer, by performing extrusion molding of a material in which the resin is a urethane-based resin and the magnetic body is a ferrite, the radio wave absorbing resin layer is formed.
